(19) United States
(12) Patent Application Publication
(10) Pub. No.: US 2009/0267680 A1
(43) Pub. Date: Oct. 29, 2009

(54) POWER DRIVING DEVICE FOR ELECTRONIC DEVICE

(75) Inventors: HSIEN-JEN CHANG, Hsinchu (TW); CHENG-JUNG LEE, Hsinchu (TW)

Correspondence Address: WPAT, PC, 7225 BEVERLY ST., ANNANDALE, VA, 22003, US

(73) Assignee: MACROBLOCK, INC., Hsinchu (TW)

(21) Appl. No.: 12/136,867

(22) Filed: Jun. 11, 2008

(30) Foreign Application Priority Data
Apr. 29, 2008 (TW) 097115766

(51) Int. Cl. G05F 1/00

(52) U.S. Cl. 327/518

(57) ABSTRACT

The present invention discloses a power driving device for an electronic device, comprising: a data input terminal capable of receiving a sequential data comprising at least a first power control sequential data and at least a second power control sequential data; an operation module capable of performing operation on the first power control sequential data and the second power control sequential data to generate a control signal; and a power control module coupled to the operation module to generate at least an output power according to the control signal. Therefore, the control signal can be used to control various power states of an electronic device.

### BACKGROUND OF THE INVENTION

1. Field of the Invention

The present invention generally relates to a power driving device for an electronic device and, more particularly, to a driving device capable of performing operation on a first power control sequential data and a second power control sequential data to generate a control signal to control various power states of an electronic device.

2. Description of the Prior Art

The light-emitting diode (LED) has been widely used in displays or as a light source because the LED is power conservative and high-efficiency. Therefore, it has become a key issue to control the chrominance, luminance or gray scale of each LED when the LED is used in a display. In a general LED display panel, an unprocessed image data is image-processed by a micro-processor or digital signal processor in a central control system into an image data capable of being displayed on the LED display panel.

However, it takes plenty of time of operation in the foresaid method, which limits the display speed of the LED display panel. Therefore, some image processing steps, such as point correction, are designed to be performed in the LED driving device.

Conventionally, there have been two approaches to control the gray scale of a LED. One is using pulse-width modulation (PWM) to display the gray scale, wherein the current in each channel is used to perform point correction. However, it is problematic in that current-based modulation results in color shift and inconsistent aging of the LED's without chrominance adjustment. Among the parameters for controlling the LED, the current supplied from the IC to the LED to control the luminance and the turn-on time are easier to be controlled. Even though the LED can be adjusted using the current to perform point correction with the turn-on time as another parameter, it may lead to some disadvantages. First, color shift is inevitable when the current varies because the color of the light from the LED depends on the current. Moreover, some LED's applied with larger current age faster than the other applied with smaller current. For chrominance adjustment, an output control signal can be acquired using an input RGB image data after matrix operation.

The other approach to control the gray scale of a LED is the use of point correction values by repeating pulse-width modulation operations. However, since the refresh rate depends on the point correction value, chrominance adjustment is not available if the refresh rate is too low. For IC products using the turn-on time to perform point correction adjustment, conventionally, to reduce the cost, the driver IC does not comprise an arithmetic unit. Therefore, a set of parameters and a set of image data are used to control a long cycle and a short cycle, respectively. Then the long cycle and the short cycle are summed to achieve multiplication. The refresh rate is the number of times a display's image is repainted. The refresh rate is higher if only the turn-on time of the short-cycle LED's is controlled. The refresh rate is lowered if the turn-on time of the long-cycle LED's is adjusted, which lengthens the display time of each pixel. However, chrominance adjustment is hard to achieve because the data is not processed.

Therefore, there exists a need in providing a driving device capable of performing operation on a first power control sequential data and a second power control sequential data to generate a control signal to control various power states of an electronic device.

### SUMMARY OF THE INVENTION

It is one object of the present invention to provide a power driving device for an electronic device to overcome the problem in the conventional driving device unable to a control signal to control various power states of an electronic device.

In order to achieve the foregoing object, the present invention provides a power driving device for an electronic device, comprising: a data input terminal capable of receiving a sequential data comprising at least a first power control sequential data and at least a second power control sequential data; an operation module capable of performing operation on the first power control sequential data and the second power control sequential data to generate a control signal; and a power control module coupled to the operation module to generate at least an output power according to the control signal.

Thereby, operation is performed on the first power control sequential data and the second power control sequential data to generate a control signal to control various power states of an electronic device.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram of a power driving device for an electronic device according to the present invention; and

FIG. 2 shows the operation of an operation module according to the present invention.

### DETAILED DESCRIPTION OF THE PREFERRED EMBODIMENT

The present invention can be exemplified by the preferred embodiment as described hereinafter.

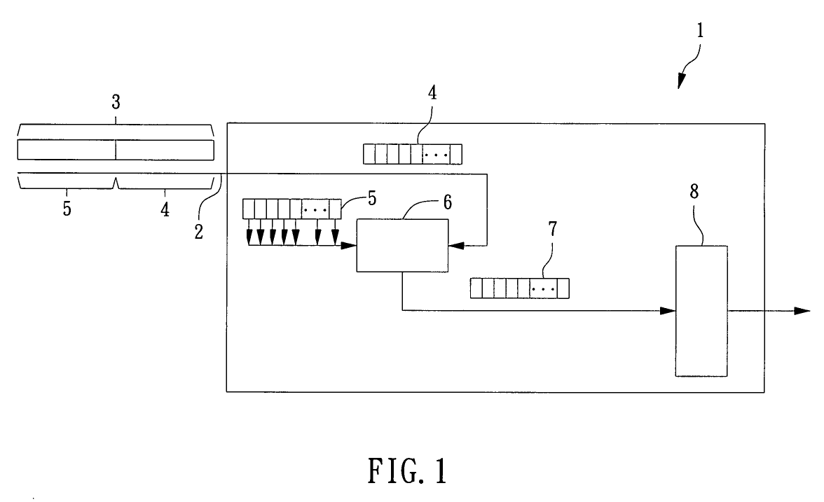

Please refer to FIG. 1, which is a schematic diagram of a power driving device for an electronic device according to the present invention. In FIG. 1, the power driving device for an electronic device 1 comprises: a data input terminal 2, an operation module 6 and a power control module 8.

The data input terminal 2 is capable of receiving a sequential data 3. The sequential data comprises a clock signal. The sequential data 3 comprises at least a first power control sequential data 4 and at least a second power control sequential data 5. The first power control sequential data 4 can be an image data, but not limited thereto. The second power control sequential data 5 can be a parameter compensation data, but not limited thereto. The parameter compensation data can be a luminance compensation data, a chrominance compensation data or a gray scale compensation data, but not limited thereto. The parameter compensation data can be used in matrix operation.

The operation module 6 can be a multiplier (such as a sequential multiplier, but not limited thereto) to perform operation on the first power control sequential data 4 and the second power control sequential data 5 to generate a control signal 7. The control signal 7 performs multiplication on the first power control sequential data 4 and the second power control sequential data 5 to generate an operation result. The first power control sequential data 4 is sequentially input into the sequential multiplier, while the second power control sequential data 5 is input in parallel into the sequential multiplier.

The power control module 8 is coupled to the operation module 6 to generate at least an output power according to the control signal 7. The operation result controls the power control module 8 using pulse-width modulation, clock-frequency modulation or cycle modulation. In the power driving device for an electronic device 1, a register (not shown) stores the parameter compensation data or a combinational logic circuit (not shown) is selecting the parameter compensation data.

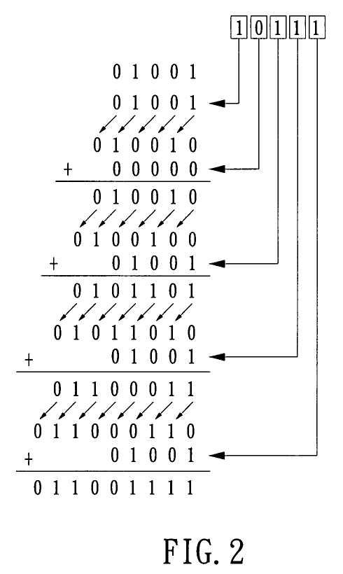

FIG. 2 shows the operation of an operation module according to the present invention. Please refer to FIG. 2 and FIG. 1, the operation for multiplying the first power control sequential data 4 and the second power control sequential data 5 to generate an operation result is described hereinafter:

Step 1: The content in the first power control sequential data 4 being 10111 is multiplied with the second power control sequential data 5 by the operation module 6 to obtain an operation result of 11001111. First, the second power control sequential data 5 is input in parallel into the operation module 6, while the first power control sequential data 4 is sequentially input into the operation module 6. Meanwhile the MSB of the first power control sequential data 4 is 1. Therefore, the content in the second power control sequential data 5 being 01001 is copied in the operation module 6.

Step 2: The clock signal shifts the operated result with 0 as the LSB.

Step 3: The second bit of the first power control sequential data 4 is input into the operation module 6. Therefore, 0 is the operator and the operated result is 010010.

Step 4: The clock signal shifts the operated result with 0 as the LSB.

Step 5: Meanwhile the third bit of the first power control sequential data 4 is 1. Therefore, the content in the second power control sequential data 5 being 01001 is selected as an operator in the operation module 6 to add to the operated result in Step 4 and obtain an operated result as 0101101.

Step 6: The clock signal shifts the operated result with 0 as the LSB.

Step 7: Meanwhile the fourth bit of the first power control sequential data 4 is 1. Therefore, the content in the second power control sequential data 5 being 01001 is selected as an operator in the operation module 6 to add to the operated result in Step 6 and obtain an operated result as 01100011.

Step 8: The clock signal shifts the operated result with 0 as the LSB.

Step 9: Meanwhile the fifth bit of the first power control sequential data 4 is 1. Therefore, the content in the second power control sequential data 5 being 01001 is selected as an operator in the operation module 6 to add to the operated result in Step 8 and obtain an operated result as 011001111.

The second power control sequential data 5 can also comprise a set of values. Meanwhile, a selection signal (not shown) is input to perform operation using a look-up table or the like. For example, 00 is input to select the content of the second power control sequential data 5 as 00001; 01 is input to select the content of the second power control sequential data 5 as 01001; 10 is input to select the content of the second power control sequential data 5 as 10001; and 11 is input to select the content of the second power control sequential data 5 as 11111. The power control module 8 generates the output power according to the content. The aforementioned technique is well known to those with ordinary skills in the art, and description thereof is not repeated.

The present invention has been exemplified using a second power control sequential data 5. Similarly, by inputting the first power control sequential data 4 into the operation module 6, two sets of the second power control sequential data 5 can be used to perform matrix operation as follows:

$$[ \begin{matrix}x \\ y \\ z\end{matrix} ] = [ \begin{matrix}a & d & g \\ b & e & h \\ c & f & i\end{matrix} ] [ \begin{matrix}R \\ G \\ B\end{matrix} ]$$

wherein

x=aR+dG+gB

y=bR+eG+hB

z=cR+fG+iB

wherein a, b, c, d, e, f, g, h and i represent the second power control sequential data. When the first power control sequential data R (such as red image data) is input, aR, bR, cR can be acquired. When the first power control sequential data G (such as green image data) is input, dG, eG, fG can be acquired. When the first power control sequential data B (such as blue image data) is input, gB, hB, iB can be acquired. Then, x, y, z can be acquired by addition. Such a matrix operation can be used to acquire the luminance compensation data, chrominance compensation data and gray scale compensation data for various colors.

Thereby, the operation is performed on the first power control sequential data and the second power control sequential data to generate a control signal to control various power states (such as luminance, gray scale or chrominance, but not limited thereto) of an electronic device (such as LED, but not limited thereto).

Accordingly, unlike the conventional central control system using a micro-processor or a digital signal processor, the present invention discloses a driving device capable of performing operation on a first power control sequential data and a second power control sequential data to generate a control signal to control various power states of an electronic device. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A power driving device for an electronic device, comprising:
a data input terminal capable of receiving a sequential data comprising at least a first power control sequential data and at least a second power control sequential data;
an operation module capable of performing operation on the first power control sequential data and the second power control sequential data to generate a control signal; and
a power control module coupled to the operation module to generate at least an output power according to the control signal.

2. The power driving device for an electronic device as recited in claim 1, wherein the power control module is a light-emitting diode (LED) power control module.

3. The power driving device for an electronic device as recited in claim 2, wherein the first power control sequential data is an image data.

4. The power driving device for an electronic device as recited in claim 2, wherein the second power control sequential data is at least a parameter compensation data.

5. The power driving device for an electronic device as recited in claim 4, further comprising a register for storing the parameter compensation data.

6. The power driving device for an electronic device as recited in claim 4, further comprising a combinational logic circuit capable of selecting the parameter compensation data.

7. The power driving device for an electronic device as recited in claim 4, wherein the parameter compensation data is a luminance compensation data, a chrominance compensation data or a gray scale compensation data.

8. The power driving device for an electronic device as recited in claim 7, wherein the parameter compensation data is used in matrix operation.

9. The power driving device for an electronic device as recited in claim 1, wherein the control signal is an operation result generated by performing multiplication on the first power control sequential data and the second power control sequential data.

10. The power driving device for an electronic device as recited in claim 1, wherein the operation module is a multiplier.

11. The power driving device for an electronic device as recited in claim 9, wherein the operation result controls the power control module using pulse-width modulation, clock-frequency modulation or cycle modulation.

12. The power driving device for an electronic device as recited in claim 10, wherein the multiplier is a sequential multiplier.

13. The power driving device for an electronic device as recited in claim 12, wherein the first power control sequential data is sequentially input into the sequential multiplier.

14. The power driving device for an electronic device as recited in claim 12, wherein the second power control sequential data is input in parallel into the sequential multiplier.

15. The power driving device for an electronic device as recited in claim 1, wherein the sequential data comprises a clock signal.
